(19) United States
(12) Patent Application Publication
(10) Pub. No.: US 2012/0177465 A1
(43) Pub. Date: Jul. 12, 2012

(54) METHOD AND SYSTEM FOR STORING CONTAINERS IN AND RETRIEVING CONTAINERS FROM A STORAGE RACK BY MEANS OF A SATELLITE VEHICLE

(76) Inventor: Roland Koholka, Lannach (AT)

(21) Appl. No.: 13/496,008

(22) PCT Filed: Sep. 7, 2010
(86) PCT No.: PCT/EP2010/005472

§ 371 Date: Mar. 14, 2012

(30) Foreign Application Priority Data
Sep. 15, 2009 (DE) 10 2009 041 590.4

(51) Int. Cl. B65G 1/06; B65G 1/04

(52) U.S. Cl. 414/279; 414/807

(57) ABSTRACT

The invention relates to a method and system for storing containers (1a, 1b) in, and retrieving the containers from, a storage rack (2) including storage rack levels (3) arranged one above the other. Containers can be stored in, and retrieved from, said storage rack levels by a satellite vehicle (4). The containers can be displaced horizontally to and from a lift (5) preferably located in a storage rack passage (G), and can also be moved vertically in the lift, along with the satellite vehicle, to at least one conveyor mechanism level (E) in the region of the storage rack. The containers being transported on the satellite vehicle to and from the conveyor mechanism level are loaded and unloaded on the level of the conveyor mechanism level. The satellite vehicle (4) is loaded and unloaded on the level of the conveyor mechanism level (E) using a loading and unloading device (V) arranged outside of the satellite vehicle, and which is preferably stationary.

### CROSS REFERENCE TO RELATED APPLICATIONS

This application is a United States National Phase application of International Application PCT/EP2010/005472 and claims the benefit of priority under 35 U.S.C. §119 of German Patent Application DE 10 2009 041 590.4 filed Sep. 15, 2009, the entire contents of which are incorporated herein by reference.

### FIELD OF THE INVENTION

The present invention pertains to a method and a system for loading and retrieving containers (defined as not only specifically containers but also boxes, shelves, other containers, etc.) into or from a storage rack with storage rack levels arranged one on top of another, in which the containers can be loaded and retrieved via single-level bay storage and retrieval units in the form of rail-borne, driven, autonomic satellite vehicles and can be horizontally transferred to an elevator preferably in a storage rack aisle and can be vertically displaced together with the satellite vehicle in the elevator to at least one elevator level in the area of the storage rack, wherein the containers delivered and removed on the elevator level are loaded onto and unloaded from the satellite vehicles at the level of the elevator level.

### BACKGROUND OF THE INVENTION

According to the state of the art, there are shuttle systems, in which the shuttles or single-level bay storage and retrieval vehicles, also called satellite vehicles, are not assigned to a certain storage rack level. These systems use an elevator, which is mounted on the front side at the storage rack, preferably at the end of a storage rack aisle of a double storage rack in order to bring the satellite vehicles to the corresponding storage rack levels and to pick them up again there.

The elevator level is a special level here. The container to be loaded or retrieved is taken over there by means of the load pick-up means of the satellite vehicle from the elevator or released onto the elevator. For reasons of mobility and low energy demand for one transportation, the satellite vehicle is a simple, lightweight, displaceable, self-propelled component as a whole, whose load pick-up means, which is not displaceable vertically, is likewise lightweight and has simple container-handling means, for example, telescopes for loading and retrieving in the storage rack and at the level of the elevator level.

The capacity of the shuttle system can be scaled with the number of shuttles or satellite vehicles. The capacity of the entire system is limited by the capacity of the elevator, because the number of shuttles working in parallel, and hence the throughput of the levels can be adapted depending on the length of the rack and the number of levels. The container cycle time on the elevator level is an important component of the elevator cycle time. To increase the throughput, it must be achieved that the unloading and loading of the shuttle on the elevator level takes place rapidly in order to be able to increase the throughput of the elevator. To achieve this goal, i.e., a faster unloading and loading of a shuttle, the mechanism and drive of the load pick-up means of the mobile shuttle must be designed such that they are faster and hence more powerful. Since the load pick-up means is necessary on each shuttle and accounts for a considerable percentage of the cost and weight of the shuttle, it is easily possible to reduce the loading and unloading times as desired.

### SUMMARY OF THE INVENTION

Based on the above-mentioned state of the art, the object of the present invention is to set up a short loading and unloading time for a satellite vehicle on the elevator level in a method and satellite vehicle system of the type described in the introduction with simple means, without compromising the mobility and energy demand of the satellite vehicle.

The basic object of the present invention is accomplished by a method and a system for loading and retrieving containers into or from a storage rack with storage rack levels, which are arranged one on top of another and in which the containers can be loaded and from which they can be retrieved via single-level bay storage and retrieval units in the form of rail-borne, driven, autonomic satellite vehicles and can be horizontally displaced to an elevator and displaced vertically together with the satellite vehicle in the elevator to at least one elevator level in the area of the storage rack, wherein the containers delivered and removed on the elevator level are loaded onto and unloaded from the satellite vehicles at the level of the elevator level.

The essence of the method according to the present invention is that at the level of the elevator level, the loading and unloading of the satellite vehicle is assumed by a preferably stationary loading and unloading device arranged outside the satellite vehicle.

The loading of the container delivered and the unloading of the container to be removed onto and from the satellite vehicle preferably take place simultaneously at the level of the elevator level. Especially short container cycle times are obtained as a result.

However, the unloading of the container to be removed and the loading of the container delivered onto and from the satellite vehicle may also take place at the level of the elevator level sequentially, i.e., one after another in time, namely, the unloading of the container to be removed taking place first and the loading of the empty satellite vehicle with a new container delivered thereafter.

If a plurality of elevator levels arranged one on top of another are present in the system, the loading and unloading device according to the present invention can optionally be displaced vertically from one elevator level to another elevator level preferably in the elevator that is already present or displaced over another path.

A system according to the present invention is characterized especially in that the loading and unloading device located outside the satellite vehicle at the level of the elevator level for loading and unloading the satellite vehicle is rigidly fastened on the elevator level or is rigidly fastened on the elevator platform of the elevator.

If a plurality of elevator levels are present, the stationary loading and unloading device can be preferably detached from the elevator level and optionally displaced to another elevator level or displaced vertically before it is again fixed or locked there. If the loading and unloading device is already rigidly mounted on the elevator platform, a simple vertical displacement of the elevator platform is sufficient to transport the loading and unloading device from one elevator level into another elevator level.

The stationary loading and unloading device may preferably have an adjustable first cross pusher or a first belt-type transfer unit for loading the satellite vehicle with a positioned container, which can be delivered on a first conveyor on the elevator level, wherein the container to be loaded optionally pushes out a container of the satellite vehicle, which said container is to be pushed out.

The stationary loading and unloading device may correspondingly have an adjustable second cross pusher or second belt-type transfer unit for unloading a positioned container from the satellite vehicle before loading or simultaneously with the loading of a newly delivered container, wherein the unloaded container can be removed on a second conveyor on the elevator level.

In particular, the first cross pusher and second cross pusher are designed as a single double pusher for simultaneous loading and unloading.

It is especially advantageous if the satellite vehicle has a load pick-up means with driven roller conveyor system, which optionally supports the loading and unloading of the satellite vehicle at the level of the elevator level.

The satellite vehicle may have a load pick-up means with at least one telescopic arm for loading and retrieving a container into or from a storage rack located in a storage rack level of the storage rack, wherein the telescopic arm or telescopic arms also supports/support or assumes/assume the unloading of a container to be removed from the satellite vehicle at the level of the elevator level, especially if the satellite vehicle is not loaded with a new container, which could push out the container to be discharged.

To optimize the loading time and unloading time on the elevator level, a device is thus proposed according to the present invention, which assumes the loading and unloading of the mobile shuttle.

Four different variants are preferably proposed:

1) A device that carries out the unloading and subsequent loading fast but sequentially (by means of pushers and/or hooks).
2) A device that carries out the unloading and loading simultaneously and thus saves additional time (double pusher or transfer with double pusher).
3) A device in which the container to be unloaded is pushed off from the shuttle by the container to be loaded. If no container is available, the load pick-up means of the shuttle is used for unloading (single pusher or transfer with pusher).
4) A device that also uses parts of the shuttle to achieve a fast change of containers (transfer with rollers or belt-type transfer units).

The advantage of all these devices is that these devices are stationary and are needed as a single unit each per elevator level (there may be a plurality of elevator levels per elevator). As a result, the shuttle can be made as inexpensive and as lightweight as possible, because the time-critical operations of container change at the level of the elevator level are not carried out by the shuttle itself, at best only with a partial involvement of the shuttle, but by a separate stationary loading and unloading device, which can be designed for higher capacity and with a larger size, because it is not included in the moved and accelerated masses of the shuttle, as a result of which especially fast container changes can be reached or especially short container cycles times are obtained.

All the devices that can actively push or remove a container onto or from a load pick-up means of the shuttle and are used to increase the container cycle times at the shuttle are considered for use as loading and unloading devices, especially the use of a stationary loading and unloading device on the elevator level, the use of a loading and unloading device, which is assigned to the elevator, as well as the use of a loading and unloading device, which can be displaced on a separate mechanism between a plurality of elevator levels.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a system for loading and retrieving containers into and from a storage rack by means of a satellite vehicle with a loading and unloading device according to the present invention in a first embodiment in one position in the method during the loading into and retrieval from the storage rack with loading and unloading of containers onto and from a satellite vehicle in a elevator level;

FIG. 2 is a perspective view of the system for loading and retrieving containers into and from the storage rack by means of the satellite vehicle with the loading and unloading device according to the present invention in the first embodiment in another position in the method during the loading into and retrieval from the storage rack with loading and unloading of containers onto and from the satellite vehicle in the elevator level;

FIG. 3 is a perspective view of the system for loading and retrieving containers into and from the storage rack by means of the satellite vehicle with the loading and unloading device according to the present invention in the first embodiment in yet another position in the method during the loading into and retrieval from the storage rack with loading and unloading of containers onto and from the satellite vehicle in the elevator level;

FIG. 4 is a perspective view of the system for loading and retrieving containers into and from the storage rack by means of the satellite vehicle with the loading and unloading device according to the present invention in the first embodiment in yet another position in the method during the loading into and retrieval from the storage rack with loading and unloading of containers onto and from the satellite vehicle in the elevator level;

FIG. 5 is a perspective view of the system for loading and retrieving containers into and from the storage rack by means of the satellite vehicle with the loading and unloading device according to the present invention in the first embodiment in yet another position in the method during the loading into and retrieval from the storage rack with loading and unloading of containers onto and from the satellite vehicle in the elevator level;

FIG. 6 is a perspective view of the system for loading and retrieving containers into and from the storage rack by means of the satellite vehicle with the loading and unloading device according to the present invention in the first embodiment in yet another position in the method during the loading into and retrieval from the storage rack with loading and unloading of containers onto and from the satellite vehicle in the elevator level;

FIG. 7 is a perspective view of the system for loading and retrieving containers into and from the storage rack by means of the satellite vehicle with the loading and unloading device according to the present invention in the first embodiment in yet another position in the method during the loading into and retrieval from the storage rack with loading and unloading of containers onto and from the satellite vehicle in the elevator level;

FIG. 8 is a perspective view of one position in a method for a system in a second embodiment;

FIG. 9 is a perspective view of another position in the method for the system in the second embodiment;

FIG. 10 is a perspective view of yet another position in the method for the system in the second embodiment;

FIG. 11 is a perspective view of yet another position in the method for the system in the second embodiment;

FIG. 12 is a perspective view of yet another position in the method for the system in the second embodiment;

FIG. 13 is a perspective view of yet another position in the method for the system in the second embodiment;

FIG. 14 is a perspective view of yet another position in the method for the system in the second embodiment;

FIG. 15 is a perspective view of yet another position in the method for the system in the second embodiment;

FIG. 16 is a perspective view of yet another position in the method for the system in the second embodiment; and

FIG. 17 is a perspective view of yet another position in the method for the system in the second embodiment.

### DESCRIPTION OF THE PREFERRED EMBODIMENTS

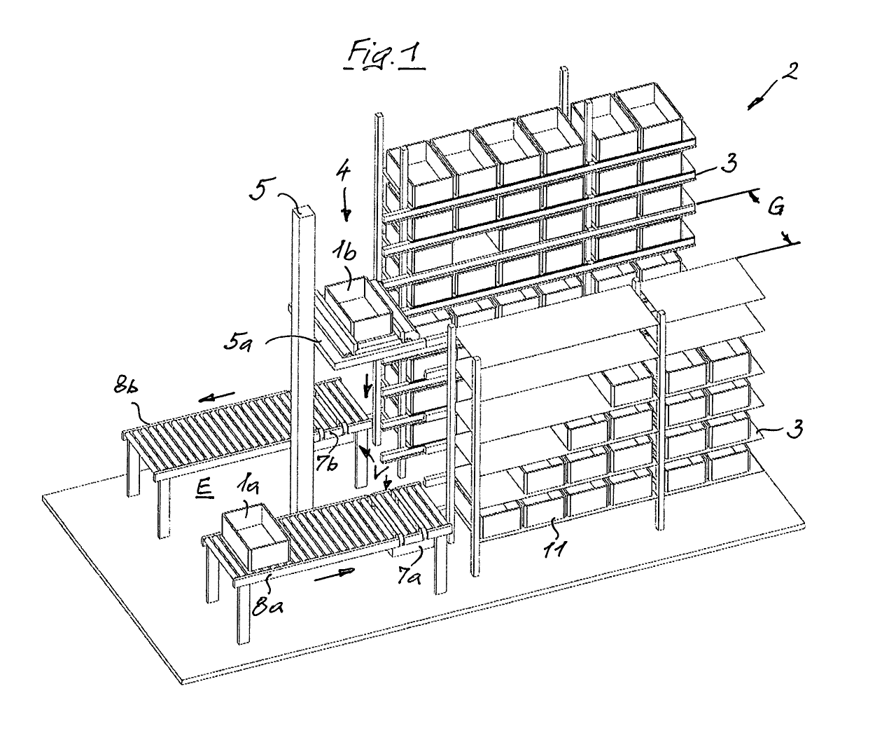

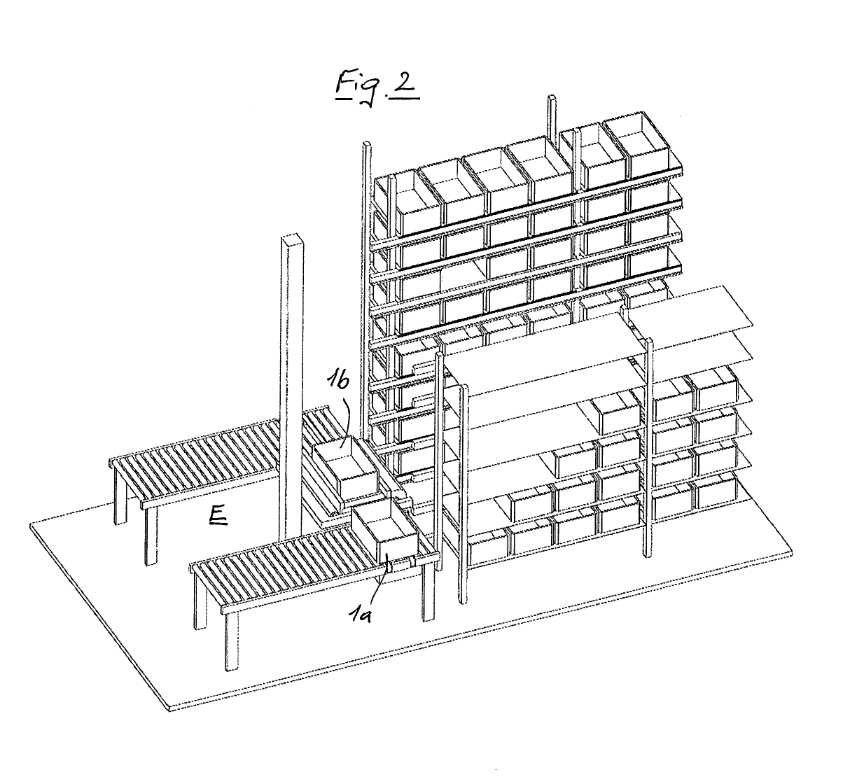

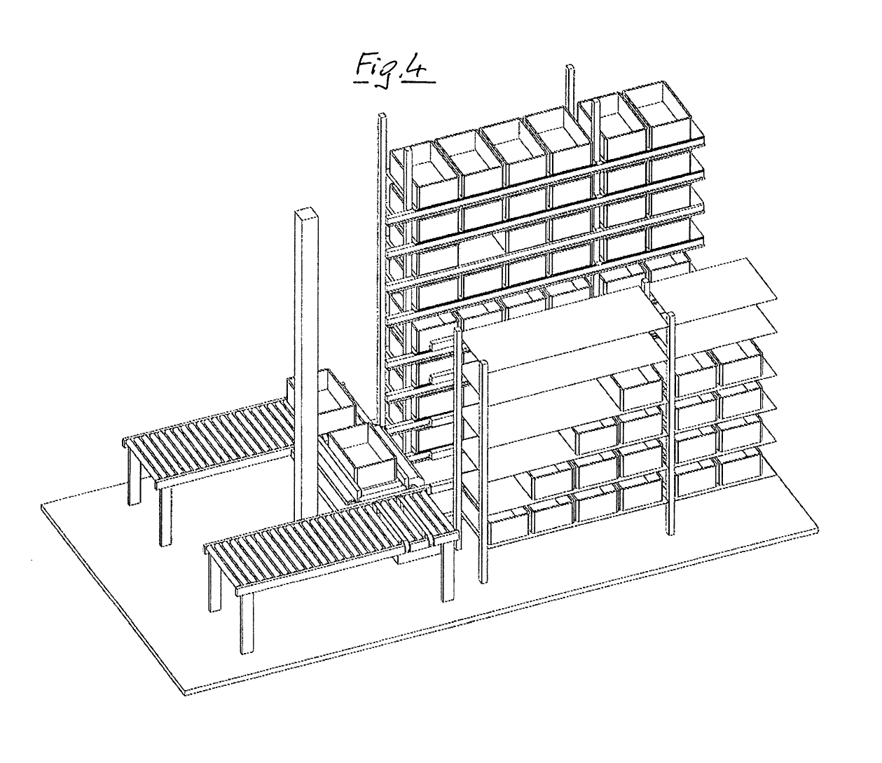

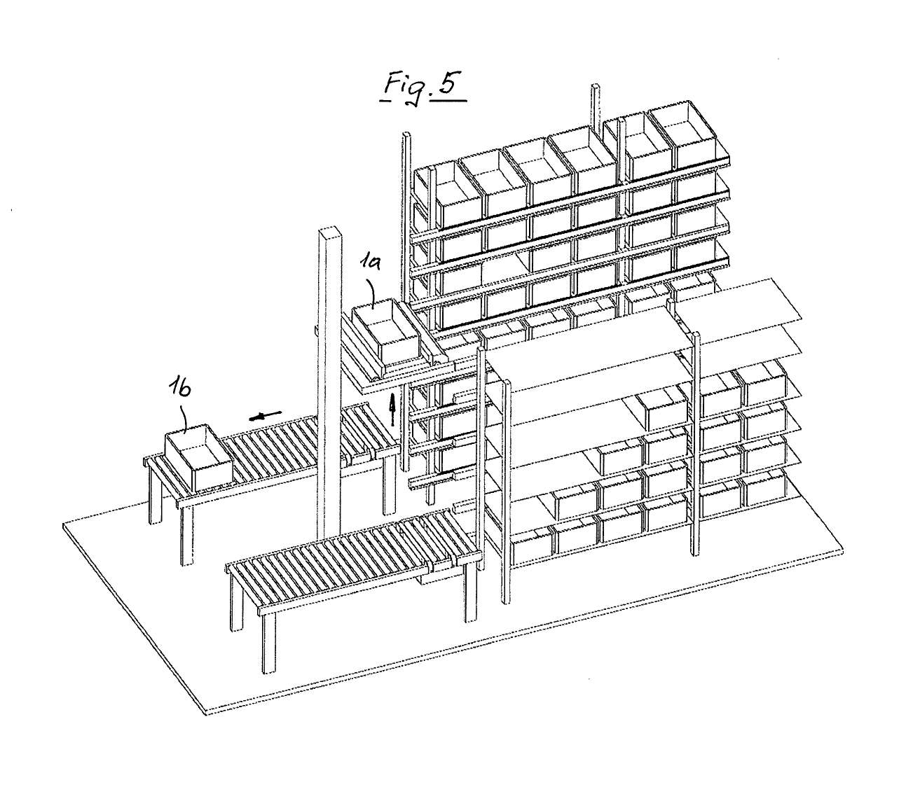

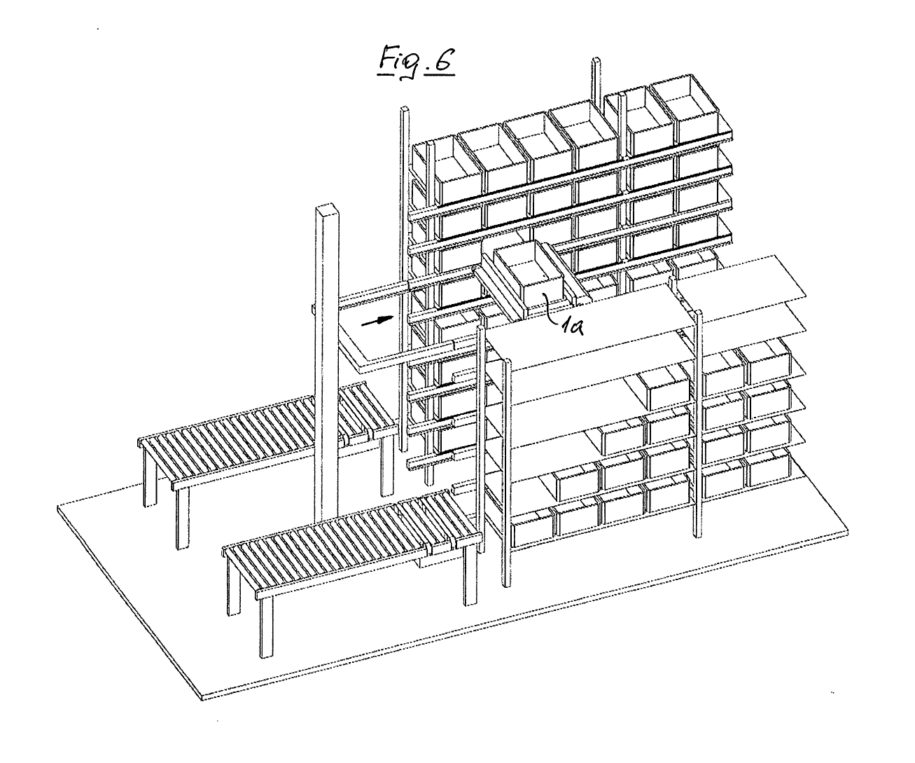

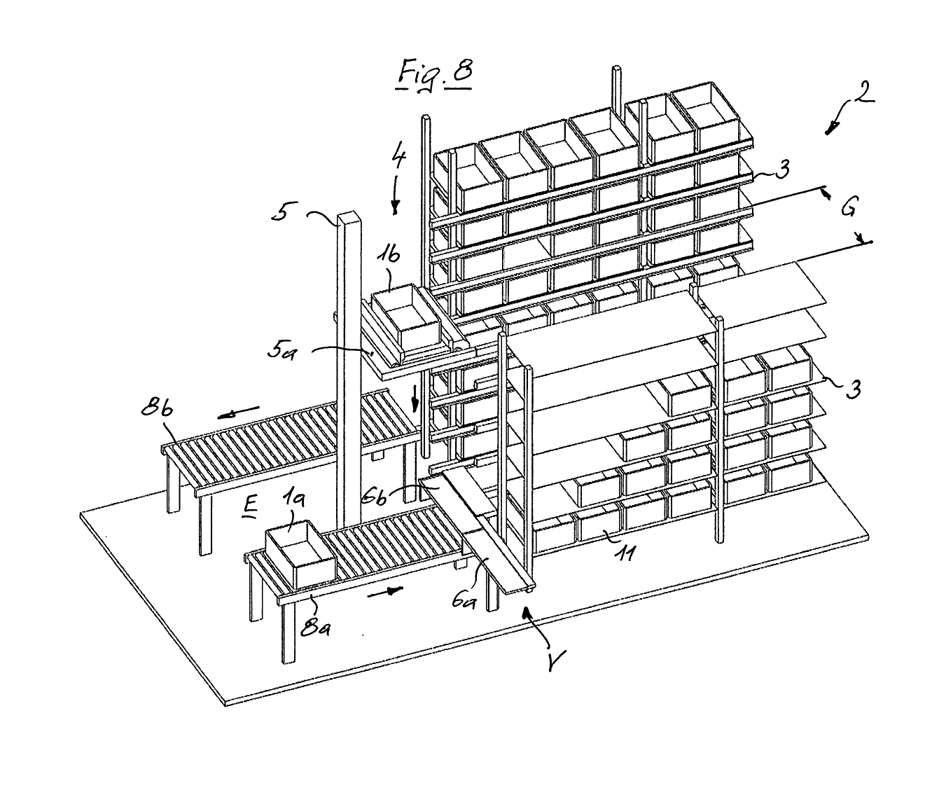

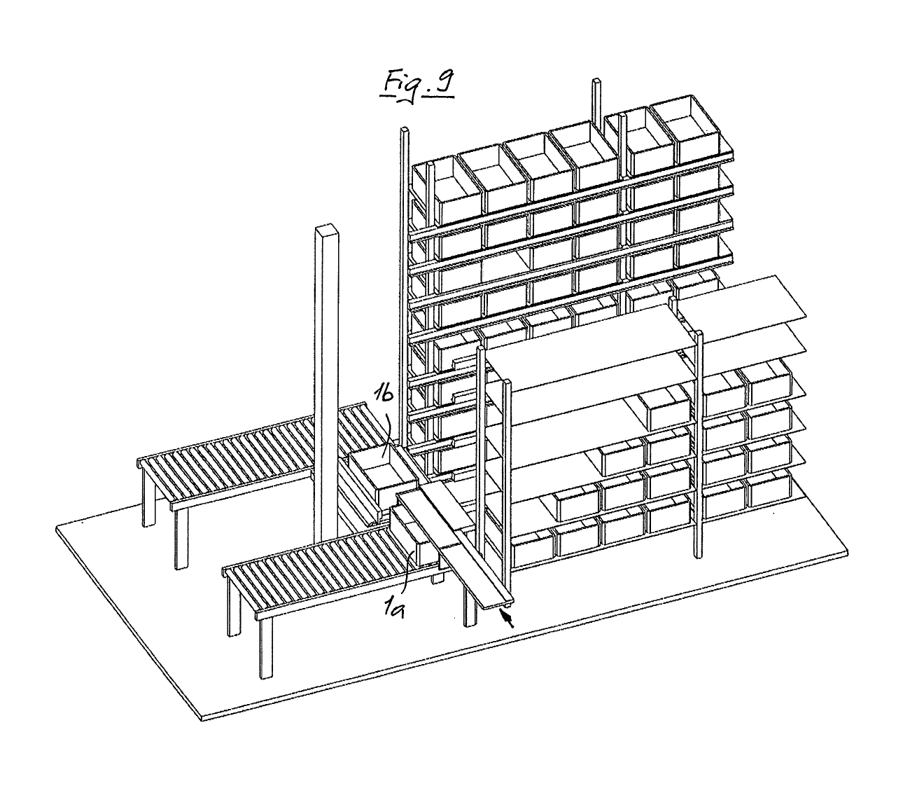

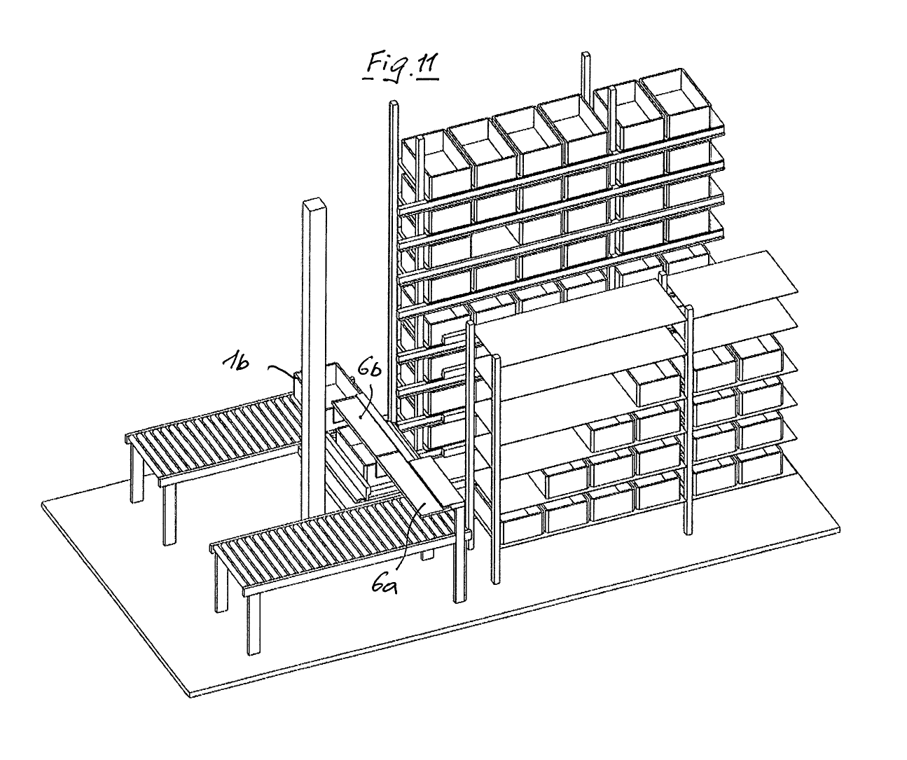

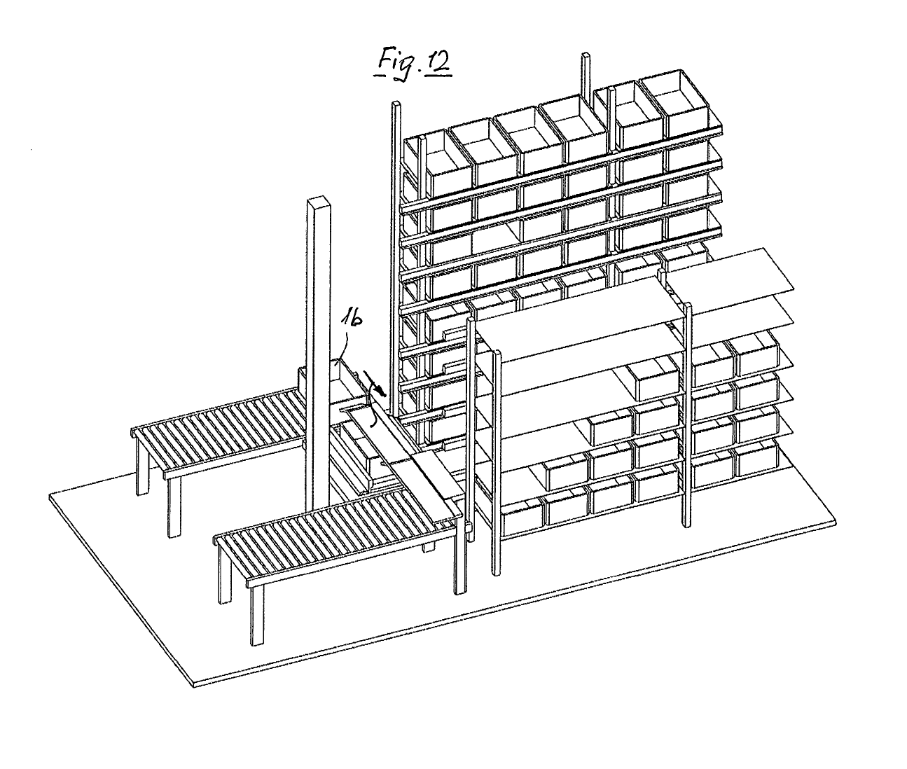

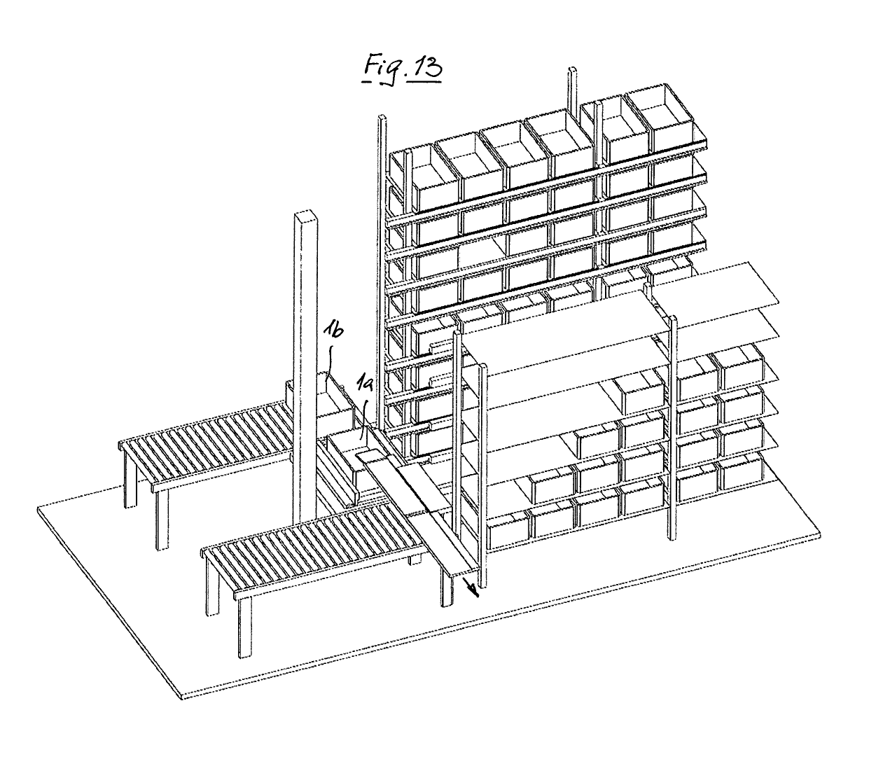

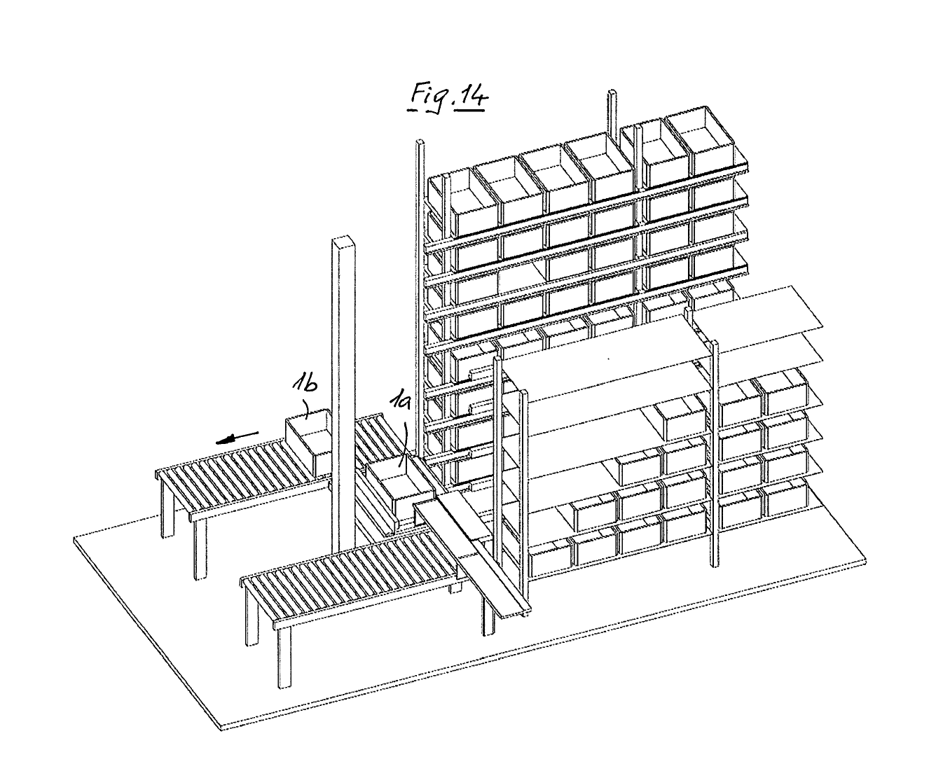

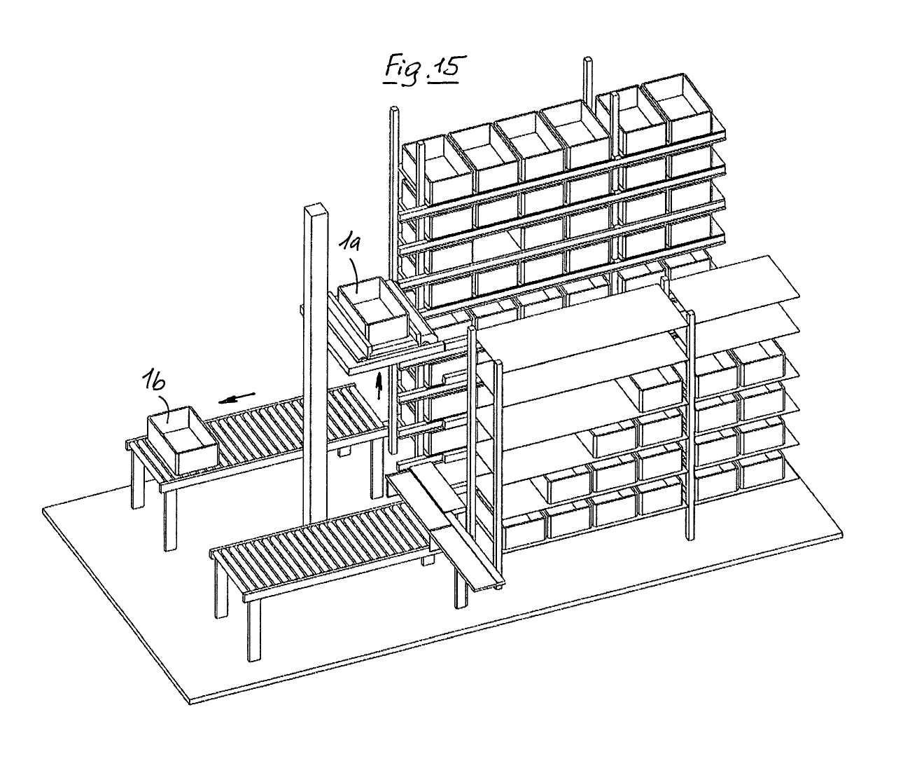

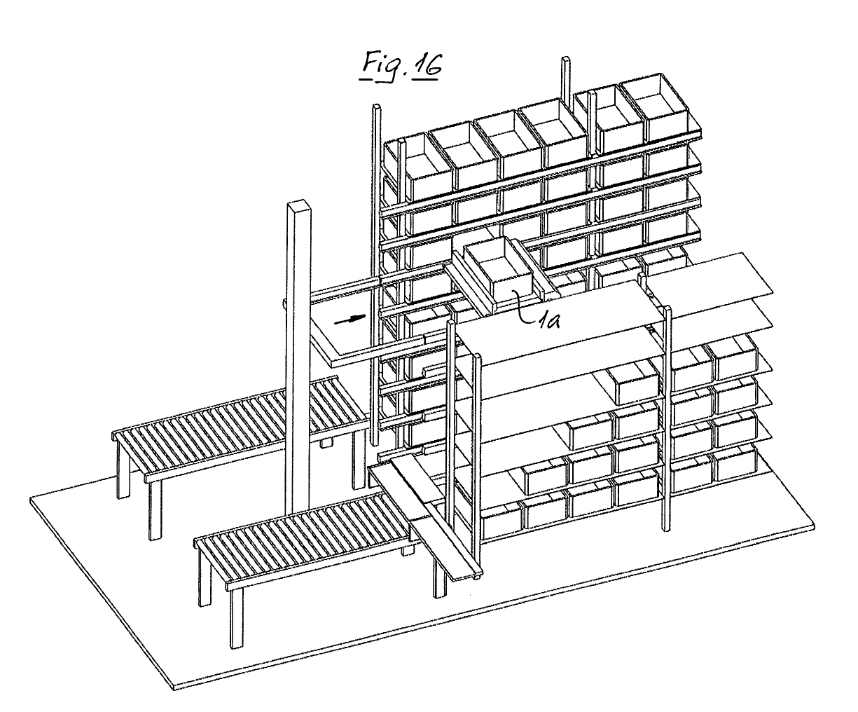

FIGS. 1 through 7 as well as FIGS. 8 through 17 show two embodiment variants of a system for loading and retrieving containers 1a, 1b into or from a storage rack 2 with storage rack levels 3 arranged one on top of another, into which the containers can be loaded and from which they can be retrieved via single-level bay storage and retrieval units in the form of rail-borne, driven, autonomic satellite vehicles 4 and displaced horizontally from and to an elevator 5 in a storage rack aisle G and can be vertically transferred together with the satellite vehicle in the elevator onto an elevator level E in the area of the storage rack, wherein the containers 1a, 1b delivered and removed on the elevator level are loaded onto and unloaded from the satellite vehicles 4 at the level of the elevator level E.

The storage rack 2 is designed as a double rack comprising two individual racks located at spaced locations from one another, between which the storage rack aisle G extends. Each individual rack has storage rack levels 3 arranged one on top of another at equal height with respective storage compartments 11 each located next to each other, in which a container each can be stored.

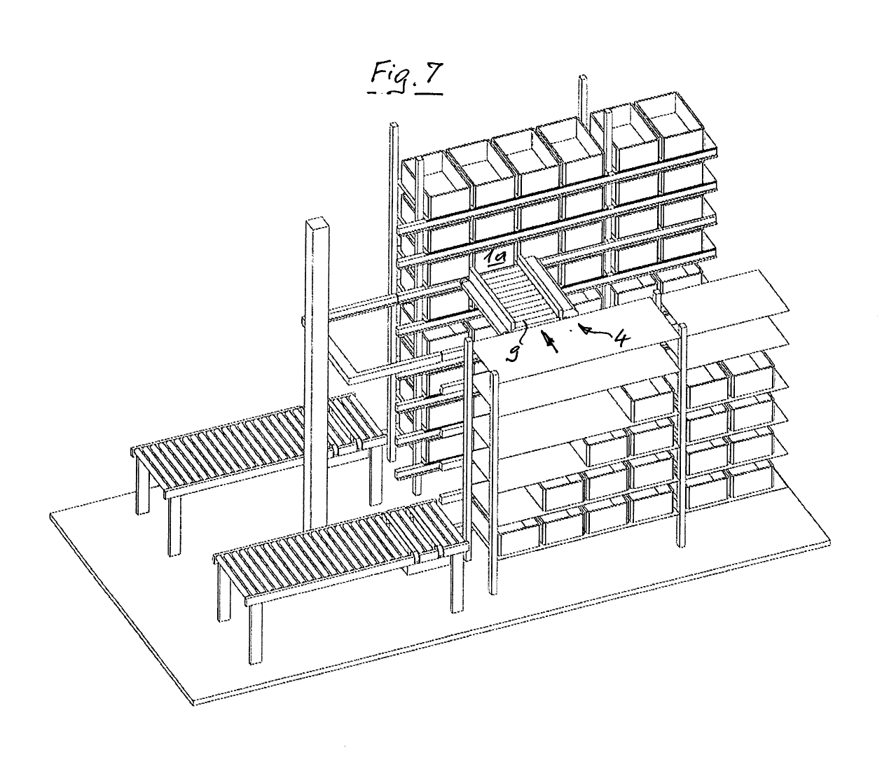

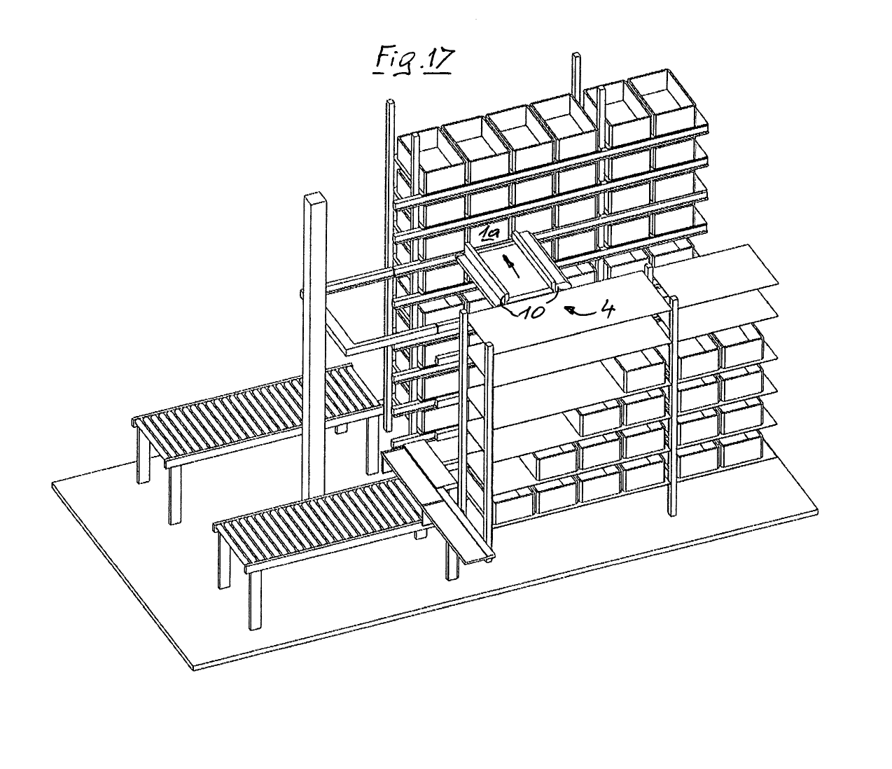

The loading and retrieval are carried out in the known manner, for example, by means of driven roller conveyor system 9 in the first embodiment variant with reference to FIG. 7 or by means of lateral telescopic arms 10 in the second embodiment variant with reference especially to FIG. 17, which is provided each on a load pick-up means of the satellite vehicle 4.

Elevator 5, on the elevator platform 5a of which a satellite vehicle each of the system can be transported along with container 1a, 1b vertically between each storage rack level 3 and the horizontal elevator level E, is located in both embodiment variants at the end of the storage rack aisle G shown on the left in the drawings.

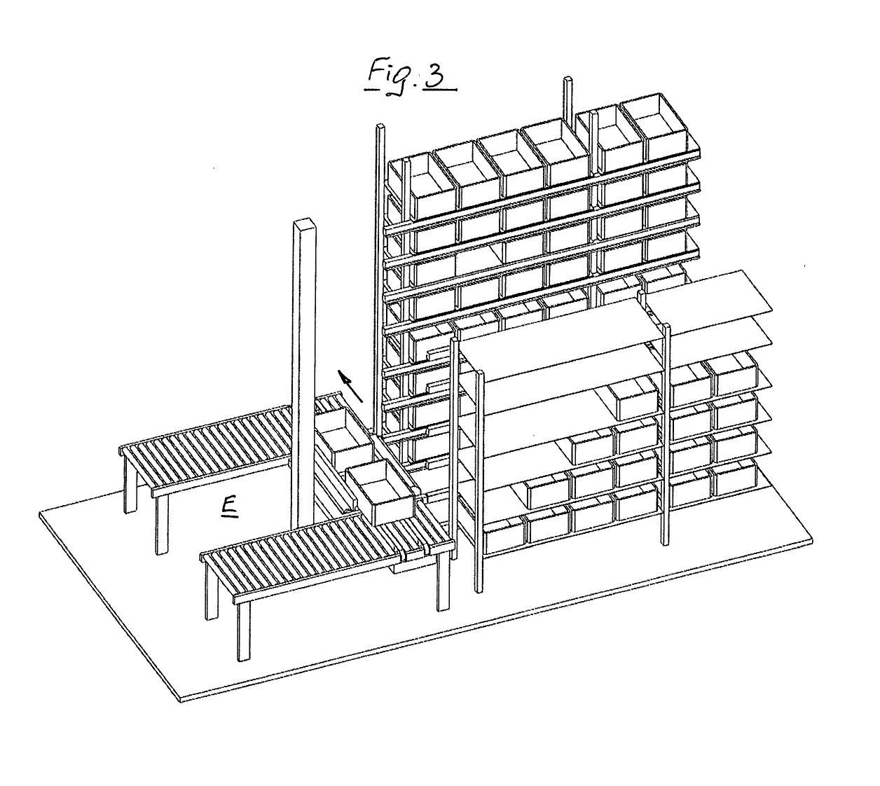

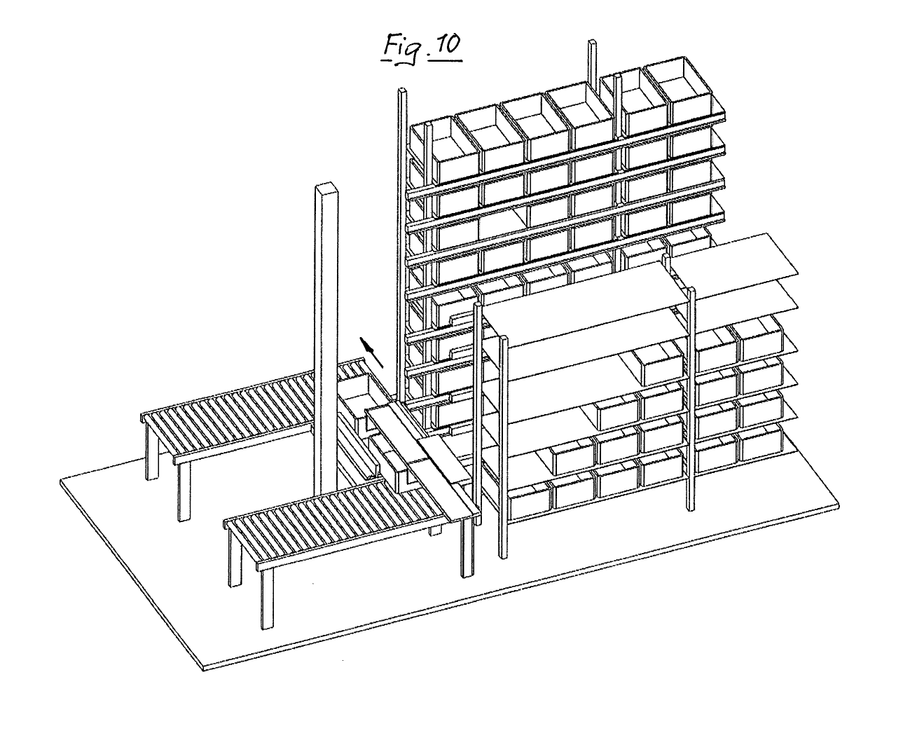

A first conveyor 8a and a second conveyor 8b according to the prior-art roller conveyor system, both of which extend in parallel to one another and are located at spaced locations from one another, are located on the horizontal elevator level E. First conveyor 8a extends directly in the extension of the front individual rack of storage rack 2 located in the drawings, and the second conveyor 8b is located directly in the extension of the rear individual rack located in the drawings. The distance between the first and second conveyors 8a, 8b corresponds to the width of the elevator platform 5a of elevator 5, which establishes in its lower position a flush, direct transition between the load pick-up means of the satellite vehicle and the two ends of the conveyors 8a and 8b, which ends are on the right according to the drawings, so that a container 1b deposited on the load pick-up means of the satellite vehicle is removed by container-handling means for retrieval on the second conveyor 8b in the direction of the arrow, and a container 1a delivered on the first conveyor 8a in the direction of the arrow can be pushed in the positioned end position, which is the right-hand position according to the drawings, onto the empty load pick-up means of the satellite vehicle in the first embodiment variant especially in reference to FIG. 3 and especially in the second embodiment variant especially with reference to FIG. 10.

The container-handling means, which make possible the pushing on and off of the containers at the level of the elevator level E, are located according to the state of the art on the satellite vehicle.

The essence of the present invention is that the above-mentioned pushing on and off of the containers or the loading and unloading of the satellite vehicle 4 at the level of the elevator level E is assumed by a stationary loading and unloading device V, which is arranged outside the satellite vehicle 4 and can be designed such that it has a higher capacity and is larger than the prior-art container-handling means of the satellite vehicles, because it is not included in the moved and accelerated masses of the satellite vehicle and can be designed in a specialized manner for the pure container change itself, as a result of which especially fast container changes can be set up or especially short container cycle times are obtained.

The loading and unloading device V is fastened on the elevator level E, which is shown symbolically by an E with underlining in the drawings.

For applications with a plurality of elevator levels, the loading and unloading device V may also be fastened to the elevator platform 5a or moved between the elevator levels.

All the devices that can actively push a container onto a load pick-up means of the satellite vehicle 4 or remove a container from same and are used to increase the container cycle times at the satellite vehicle.

In the first embodiment variant shown in FIGS. 1 through 7, the loading and unloading device V is a first and second belt-type transfer unit 7a, 7b, which are integrated each in the first and second conveyors 8a, 8b at the end and make possible the transverse displacement of a container placed on the belt-type transfer unit together with the roller conveyor system 9 of the load pick-up means of the satellite vehicle.

In the second embodiment variant shown in FIGS. 8 through 17, the loading and unloading device V is a first and second pusher 6a, 6b, which are assigned each to the first and second conveyors 8a, 8b at the end and make possible the transverse displacement of a placed container. In the second embodiment variant shown, both pushers 6a, 6b are designed as a double pusher, which makes it possible to push in and out simultaneously a container 1a delivered on the first conveyor 8a and a container 1b to be removed on the second conveyor 8b. The first and second pushers 6a, 6b have single-acting pushing elements, which can be tilted up during a return stroke.

While specific embodiments of the invention have been shown and described in detail to illustrate the application of the principles of the invention, it will be understood that the invention may be embodied otherwise without departing from such principles.

1. A method for loading and retrieving containers into or from a storage rack with storage rack levels, which are arranged one on top of another and in which the containers can be loaded and from which the containers can be retrieved via single-level bay storage and retrieval units in the form of rail-borne, driven, autonomic satellite vehicles and can be horizontally displaced to an elevator and displaced vertically together with the satellite vehicle in the elevator to at least one elevator level in an area of the storage rack, wherein the containers are delivered and removed on the at least one elevator level, the process comprising:
loading and unloading of the satellite vehicle at a level of the at least one elevator level by a loading and unloading device arranged outside the satellite vehicle.

2. A method in accordance with claim 1, wherein the loading of the container delivered onto the satellite vehicle and the unloading of the container to be removed from the satellite vehicle take place simultaneously at the level of the elevator level.

3. A method in accordance with claim 1, wherein the unloading of the container to be removed from the satellite vehicle and the loading of the container onto the satellite vehicle take place sequentially at the level of the elevator level.

4. A method in accordance with claim 1, wherein the loading and unloading device is vertically transferred or moved from the elevator level to another elevator level in the elevator.

5. A system for loading and retrieving containers, the system comprising:
a single-level bay storage and retrieval unit comprising at least one rail-borne, driven, autonomic satellite vehicle;
an elevator;
a storage rack with storage rack levels, said storage rack levels being arranged one on top of another and into which the containers can be loaded and from which the containers can be retrieved via said at least one satellite vehicle and displaced horizontally from and to said elevator in a storage rack aisle via said at least one satellite vehicle and displaced vertically together with the satellite vehicle in the elevator to at least one elevator level in an area of the storage rack, wherein the containers are delivered and removed on the at least one elevator level; and
a loading and unloading device located outside the satellite vehicle at a level of the elevator level for loading and unloading the satellite vehicle, said loading and unloading device being one of rigidly fastened on the elevator level and rigidly fastened on an elevator platform of the elevator.

6. A system in accordance with claim 5, wherein the loading and unloading device is one or more of detachable from the elevator level and vertically displaceable to another elevator level.

7. A system in accordance with claim 5, wherein the loading and unloading device has one of an adjustable first pusher and a first belt-type transfer unit for loading the satellite vehicle with a positioned container, said positioned container being delivered on a first conveyor on the elevator level, wherein the positioned container pushes out a container to be unloaded during loading the satellite vehicle.

8. A system in accordance with claim 7, wherein the loading and unloading device has one of an adjustable second pusher and a second belt-type transfer unit (7b) for unloading a positioned container from the satellite vehicle before one of loading a new container and simultaneously loading a new container, wherein the positioned container unloaded from the satellite vehicle is removed on a second conveyor on the elevator level.

9. A system in accordance with claim 8, wherein the first pusher and the second pusher are designed as a single double pusher for simultaneous loading and unloading.

10. A system in accordance with claim 5, wherein the satellite vehicle has a load pick-up means with driven roller conveyor system for supporting the loading and unloading of the satellite vehicle at the level of the elevator level.

11. A system in accordance with claim 5, wherein the satellite vehicle has a load pick-up means with at least one telescopic arm for at least one of loading a container into a storage compartment located in a storage rack level of the storage rack and retrieving a container from the storage compartment located in the storage rack level of the storage rack.

12. A system in accordance with claim 11, wherein the unloading of a container to be removed from the satellite vehicle at the level of the elevator level is carried out by the telescopic army.

13. A system in accordance with claim 11, wherein the unloading of a container to be removed from the satellite vehicle at the level of the elevator level is carried out by the telescopic arm if the satellite vehicle is not loaded with a new container.

14. A method in accordance with claim 1, wherein said loading and unloading device is stationary.

15. A method in accordance with claim 1, wherein the loading and unloading device is vertically moved from the at least one level of said elevator level to another level in the elevator.

16. A method in accordance with claim 1, wherein said loading and unloading device is one of rigidly fastened on the at least one level of said elevator and rigidly fastened on an elevator platform of said elevator

17. A method, comprising:
providing a storage rack comprising storage rack levels, each of said storage rack levels being arranged at a position above another one of said storage rack levels;
providing at least one storage and retrieval unit comprising a vehicle, said vehicle being movable in a horizontal direction;
providing an elevator;
moving said vehicle in a vertical direction via said elevator such that said vehicle moves to at least one level of said elevator, said at least one level of said elevator being in an area of said storage rack;
providing a loading and unloading device, said loading and unloading device being arranged at a position outside said vehicle;
at least one of delivering one container to said at least one level of said elevator and removing another container from said at least one level of said elevator;
at least one of arranging said one container on said vehicle via said loading and unloading device with said vehicle on said at least one level of said elevator and removing said another container from said vehicle via said loading and unloading device with said vehicle on said at least one level of said elevator.

18. A method in accordance with claim 17, wherein said one container is delivered to said satellite vehicle and said another container is removed from said vehicle simultaneously with said vehicle at said at least one level of said elevator.

19. A method in accordance with claim 17, wherein said another container is removed from said vehicle prior to said one container being arranged on the vehicle with the vehicle at said least one level of said elevator.

20. A method in accordance with claim 17, wherein said loading and unloading device is one of rigidly fastened on the at least one level of said elevator and rigidly fastened on an elevator platform of said elevator.
